(19) United States
(12) Patent Application Publication
(10) Pub. No.: US 2004/0182937 A1
(43) Pub. Date: Sep. 23, 2004

(54) Method for manufacturing a type plate for identifying an article, especially a vehicle

(76) Inventor: Albert Hiller, Mulheim (DE)

Correspondence Address: FRIEDRICH KUEFFNER, 317 MADISON AVENUE, SUITE 910, NEW YORK, NY, 10017, US

(21) Appl. No.: 10/810,925

(22) Filed: Mar. 26, 2004

Related U.S. Application Data
(62) Division of application No. PCT/EP02/09224, filed on Aug. 17, 2003.

(30) Foreign Application Priority Data
Oct. 27, 2001 (DE) 101 53 145.1

(51) Int. Cl. G06K 19/06

(52) U.S. Cl. 235/491; 156/73.5; 264/248; 340/572.1

(57) ABSTRACT

In a method for manufacturing a type plate to be fastened on an article, a plate member is prepared of a temperature-resistant thermoplastic-material. The plate member forms a housing with a shell-shaped receptacle. A transponder having an empty memory is inserted into the receptacle. The receptacle is closed off by a lid of a temperature-resistant thermoplastic material. In the contact zone between the housing and the lid, the thermoplastic materials of the housing of the plate member and the lid are melted and a welding seam is formed. Data is applied in an optically readable form on a visible side of the type plate. At least some of the data is additionally input electromagnetically into the memory of the transponder so that the data that is input into the memory is readable electronically.

This application is a divisional of international application PCT/EP02/09224 with an international filing date of Aug. 17, 2002, not published in the English language under PCT Article 21(2), and now abandoned.

### BACKGROUND OF THE INVENTION

1. Field of the Invention

The invention relates to a method for manufacturing a type plate to be attached after its manufacture to an article, wherein on the visible side of the type plate specific data of the article are applied to be optically readable and wherein the type plate has integrated therein a transponder. Such a type plate is used primarily in vehicles (vehicle ID plate) and contains vehicle-specific data such as the vehicle. ID number, the manufacturing year of the vehicle, and the type of engine or the like.

2. Description of the Related Art

Originally, a metal plate was used as a type plate and the data was stamped or engraved into the metal plate; after attachment of the plate to the vehicle, the data was optically readable. These type plates can be relatively easily forged. Reading of the data is often cumbersome and time-consuming.

A sticker for motor vehicles is already known (DE 100 03 881 A1) that has on its visible side readable vehicle-specific data, for example, in the form of vehicle registration information. For this purpose, a carrier layer of plastic material is provided that has labeling on one side. On either side to the carrier layer, an adhesive layer is applied, respectively, with which the sticker can be attached to a support surface. Underneath the adhesive layer on the backside, a transponder is arranged whose antennas are arranged within the adhesive layer. The transponder is arranged in an intermediate layer that, like the transponder, is initially covered by a protective paper. For adhesively attaching the sticker to the support surface, the protective paper is removed so that the transponder rests against the support surface. This type of sticker can be easily manipulated.

Moreover, a vehicle identification system is known (DE 196 07 294 A1) where the vehicle-specific data are stored, retrieved and changed in a chip by means of an induction method. This chip can be integrated directly into a motor vehicle part, for example, an engine block or a bumper. A screw connection in pre-manufactured cavities is also proposed.

In the case of a container (U.S. Pat. No. 6,302,461 B1) that is manufactured by injection molding of plastic material, it is known to integrate during injection molding of the material a transponder into the wall of the container. The transponder is arranged in a closed box as a protection against the injection-molding materials. Optically readable data are not provided. The use as a “type plate” is not possible.

For a housing of an electric switch (U.S. Pat. No. 5,893,959 A), thermoplastic material is used. This housing is comprised of a bottom shell and a lid. The lid is connected to the bottom shell by laser welding. The use of this housing as a type plate for vehicles or the like is not suggested. An optically readable labeling is not provided.

### SUMMARY OF THE INVENTION

It is an object of the present invention to develop a reliable method for manufacturing a type plate of the aforementioned kind whose data can be optically read in an easy way, on the one hand, and are still well protected, on the other hand.

In accordance with the present invention, this is achieved in that first from a temperature-resistant thermoplastic material a plate member for the type plate is manufactured that is at least partially embodied as a housing with a shell-shaped receptacle; in that a transponder is inserted into the receptacle, wherein the transponder initially has an empty memory; in that, subsequently, the receptacle is closed by a lid that has been produced prior to this also from a temperature-resistant thermoplastic material; in that, subsequently, at the contact zone between the housing and the lid, the plastic material(s) is/are melted and, in this way, a combination product comprised of the plate, the transponder, and the lid is produced; in that, on the one hand, optically readable data are applied to the visible side of the combination product, and in that, on the other hand, at least some of these optically readable data are electromagnetically input into the memory of the transponder and, subsequently, can be electronically read from the memory of the combination product from the exterior of the type plate.

According to the present invention, the plate member of the type plate has a double function. It has not only optically readable data on its visible side but also serves for receiving a transponder. The transponder is inserted into the interior of the plate member into a shell-shaped receptacle that is then closed by a lid. The plate member is manufactured of a temperature-resistant thermoplastic material and during manufacture a shell-shaped receptacle is formed. In the next step of manufacture, a transponder is inserted into this receptacle, and the receptacle is closed finally by a separately produced lid. By melting the plastic materials in the contact zone between the lid and the plate member, finally a connection is provided that produces a combination product, comprised of plate member, transponder, and data. At least some of the optically readable vehicle-specific data are input electromagnetically into the memory of the transponder integrated into the type plate. After attachment of the type plate on the vehicle, the data in the memory can be electronically read from the exterior. The electronic device within the transponder can be configured to enable only an encoded input of data into the memory so that subsequently a forgery of the vehicle-specific data in the transponder is impossible electronically. A deviation of the optically readable labeling on the visible side of the type plate is easily detectable when it is compared to the contents of the electronic memory in the transponder. Reading of the type plate visually and electronically provides redundance. In this way, a forgery-safe configuration of the type plate is achieved. Reading of the memory in the transponder is possible quickly and reliably from the exterior.

In order for the optical labeling and the memory contents of the transponder to be identical for sure, it is proposed to carry out both processes simultaneously.

### BRIEF DESCRIPTION OF THE DRAWING

In the drawing:

FIG. 1 shows in section all three components of the type plate according to the invention in an exploded view before being connected, wherein the section is taken along the stepped section line I-I shown in FIG. 2;

FIG. 2 is a plan view onto the backside of the first component of the type plate;

FIG. 3 is a plan view onto the second component of the type plate of FIG. 1;

FIG. 4 is a plan view onto the third component of the type plate of FIG. 1;

FIG. 5 shows the type plate assembled of the components of FIGS. 2 to 4 after attachment on the car body of a vehicle;

FIG. 6 shows a sectioned view of the back side of the mounted type plate of FIG. 5 along the section line VI-VI.

### DESCRIPTION OF THE PREFERRED EMBODIMENTS

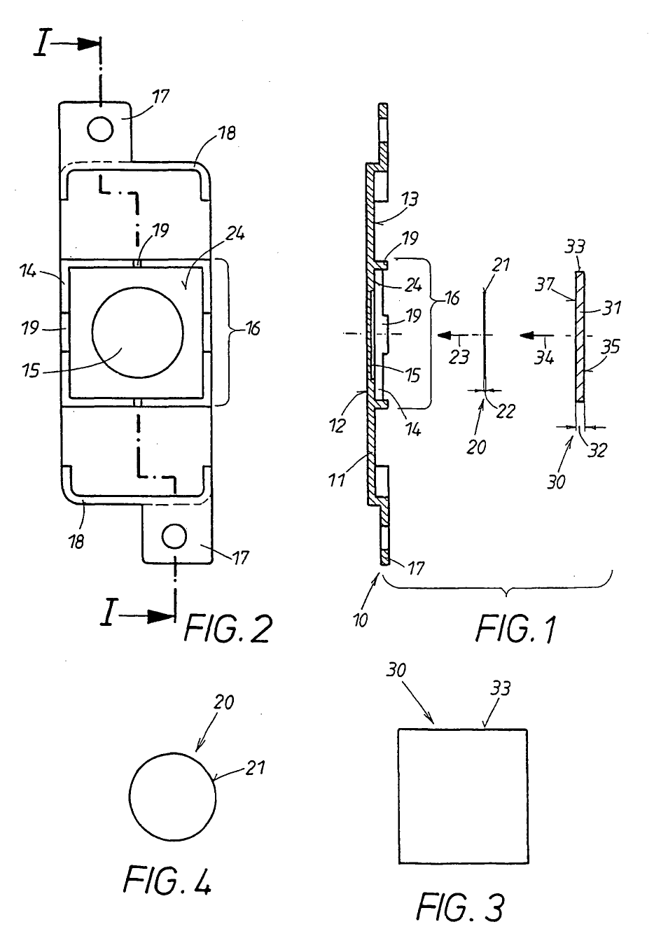

The type plate according to the invention, as already mentioned, and shown in FIG. 1, is comprised of three components 10, 20, 30. The first component is a plate member 10 of temperature-resistant, thermoplastic material 11. The plate member 10 is essentially plane on its visible side 12. However, the backside 13 of the plate has a relief profile. This profiled structure is primarily the result of a frame 14 on the back side that has a central area provided with a recess 15. This recess 15 is dimensionally matched to the second component of the type plate, i.e., the transponder 20, and provides a receptacle for it.

The transponder 20, as illustrated in FIG. 4, has a circular contour 21 and contains, as is known in the art, in its interior in addition to electronic components such as electromagnetic coils also a memory, not illustrated in detail, that is uploaded and read electromagnetically. The recess 15 is embodied in the plate member 10 so as to match the contour 21 of the transponder 20 and the thickness 22 of the transponder that can be seen in FIG. 1. Because of the frame 14 and the recess 15, the plate member 10 has a shell-shaped form in the central area so that an open housing 16 results.

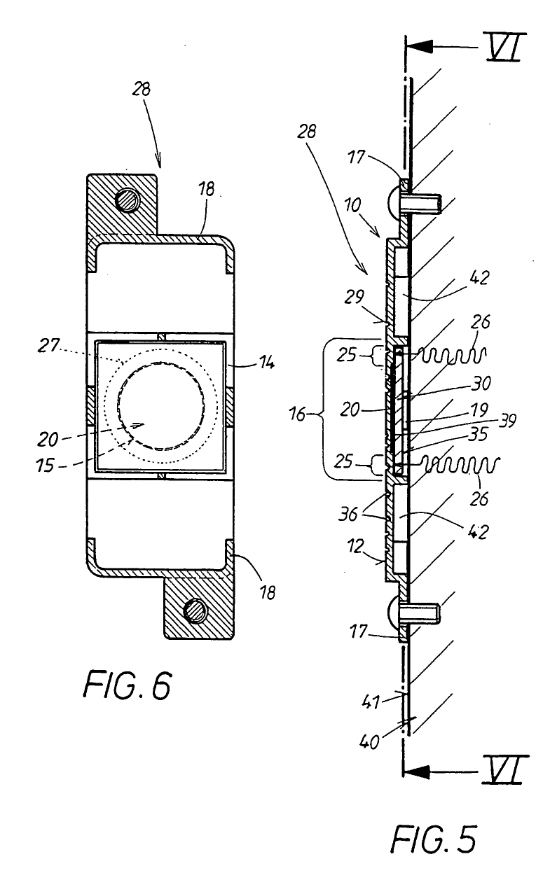

The plate member 10 comprises in its end sections two brackets 17 provided with openings that, as shown in FIG. 5, are used for attaching the plate member to a car body 40 (shown in longitudinal section and broken away). The brackets 17 are positioned lower than the visible side 12 and are flush with the stays 18 that surround in a U-shape the plate end sections on the backside 13 and that contribute to the aforementioned profiling in this way. The frame 14 is provided at some locations with legs 19 which, in the case of use, as illustrated in FIG. 5, are supported on the surface 41 of the car body 40. In this way, as illustrated in FIG. 5, free space 42 is provided between the car body 40 and the plate member 10 so that, during painting of the car body, color pigments can also reach the area underneath the type plate attached to the car body in order to be able to coat the surface 41 of the car body 40 in this area.

After completion of the profiled plate 10, the transponder 22 is inserted into the receptacle 15 of the housing 16, as illustrated by the arrow 23 in FIG. 1. In this connection, the aforementioned memory of the transponder 20 is essentially empty. After mounting in the receptacle 15, the backside of the transponder is essentially flush with the housing bottom 24. This enables mounting of the third component 30.

The third component 30 of the type plate according to the invention is a lid 30 that is comprised of a plane-parallel disk and is formed also of a temperature-resistant thermoplastic material 31. The lid 30, as illustrated in FIG. 3, has a contour 33 that is matched to the dimensions of the frame 14. The same holds true for the thickness 32 of the lid 30. After mounting (arrow 23) of the transponder 20, the lid 30 is then inserted in the direction of arrow 34 of FIG. 1 into the housing 16. This state is illustrated in FIG. 5.

As shown in FIG. 5, the inserted lid 30 fills the interior of the housing 16 but the aforementioned legs 19 project past the back side 35 of the mounted lid 30. Everywhere circumferentially about the receptacle 15, the front side 37 of the lid 30 contacts the aforementioned housing bottom 24. Into these contact zones 25 between 10 and 30, laser radiation 26 is introduced as illustrated symbolically in FIG. 5. This is possible because the laser beam 26 is within a frequency range where the plastic material 31 is essentially transparent but the plastic material 11 of the plate member 10 is absorbent. Therefore, in the contact zone 25 the plastic material 11 and/or 31 is melted. The result is a continuous line-shaped welding seam (weld) 27 that is illustrated by dots in FIG. 6 between the two parts 10, 30. The weld 27 encloses the transponder 20 in the receptacle 15 on all sides and ensures thus a media-tight enclosure.

Instead of a weld 27 produced by laser radiation 26, friction welding or ultrasound welding can also be used for realizing the welds between the two components 10, 30 of the type plate according to the invention. Because the memory in the transponder 20 is still empty, the heat development when producing the weld 27 cannot cause any damage. Only after assembling the three parts 10, 20, 30 to form the type plate according to the invention, a combination product 28 according to FIGS. 5 and 6 results, and the necessary data 29, 39 are then added to the combination product.

The combination product 28 according to the invention contains two at least partially overlapping but very different sets of data 29, 39. One data set 29 is introduced mechanically into the visible side 12 of the plate member 10. In the present case, the set of data is comprised of notches 36 that are burned into the material of the plate member 10 by laser light. The other data set 39 that can comprise in addition service data of the article is electromagnetically input into the memory of the transponder 20. According to the invention, both sets of data 29 and 39 are generated simultaneously. For the input of the electronic data set 39, encoding methods can be used that enable only authorized persons to input data into the memory. In this way, forgery of the data set 39 is excluded.

According to one embodiment, the plate member 10 is made of plastic material 11 that is opaque for laser radiation and the plate side 12 facing away from the housing 16 is provided with the optically readably data. These measures of the invention ensure a high level of security against forgery of the type plate according to the invention.

While specific embodiments of the invention have been shown and described in detail to illustrate the inventive principles, it will be understood that the:invention may be embodied otherwise without departing from such principles.

What is claimed is:

1. A method for manufacturing a type plate to be fastened on an article, the method comprising the steps of:
preparing a plate member of a temperature-resistant thermoplastic material, wherein the plate member at least partially forms a housing with a shell-shaped receptacle;
inserting a transponder having an empty memory into the receptacle;
closing off the receptacle by a lid that is produced of a temperature-resistant thermoplastic material;
subsequently, melting in the contact zone between the housing and the lid at least one of the thermoplastic materials of the housing of the plate member and the lid to form a welding seam between the housing and the lid and to form a combination product comprised of the plate member, the transponder, and the lid;
applying data in an optically readable form on a visible side of the combination product; and
inputting at least some of the data additionally electromagnetically into the memory of the transponder, wherein the data that are input into the memory are readable electronically.

2. The method according to claim 1, wherein the step of applying the data in a optically readable form and the step of inputting at least some of the data into the memory are carried out simultaneously.

3. The method according to claim 1, further comprising the step of adding service data of the article into the memory of the transponder.

4. The method according to claim 1, wherein, in the step of applying the data in an optically readable, a laser light is employed for engraving the visible side of the combination product.

5. The method according to claim 1, wherein the lid is produced of a thermoplastic material that is substantially transparent for laser radiation of a selected frequency, wherein the laser radiation is absorbed by the thermoplastic material of the housing, wherein,.in the step of melting, the laser radiation is applied to a contact zone where the thermoplastic materials of the lid and the housing contact one another.

6. The method according to claim 5, wherein, in the step of producing the plate member, the thermoplastic material is a material that is opaque for the laser radiation, and wherein, in the step of applying the data in an optically readable form, the data is applied to a side of the plate member facing away from the housing.

7. The method according to claim.1, wherein friction welding is used in the step of melting.

8. The method according to claim 1, wherein ultrasound welding is used in the step of melting.

9. The method according to claim 1, wherein, in the step of preparing the plate member, the plate member is provided with a backside having a relief profile and a recess arranged in the relief profile, wherein the receptacle is formed by the recess, wherein the lid is substantially plane, and wherein, in the step of closing off the housing, the lid is inserted into the relief profile such that the relief profile projects past a backside of the lid.

10. The method according to claim 9, wherein the recess has such a depth that the depth is substantially identical to a thickness of the transponder.

11. The method according to claim 1, wherein the step of applying the data in an optically readable form and the step of inputting at least some of the data additionally are carried out after the combination product is connected to a vehicle.
